(19) United States
(12) Patent Application Publication
(10) Pub. No.: US 2020/0023799 A1
(43) Pub. Date: Jan. 23, 2020

(54) Apparatus for Ascertaining the Surroundings for a Vehicle, Vehicle and Method for Initiating a Protective Function in the Case of an Impact Effect that is Acting upon a Vehicle

(71) Applicant: Robert Bosch GmbH, Stuttgart (DE)

(72) Inventors: Heiko Freienstein, Weil Der Stadt (DE); Mustafa Kamil, Leonberg (DE)

(21) Appl. No.: 16/513,831

(22) Filed: Jul. 17, 2019

(30) Foreign Application Priority Data
Jul. 18, 2018 (DE) 10 2018 211 917.1

(51) Int. Cl. B60R 21/0134; B60R 21/34

(52) U.S. Cl. CPC B60R 21/0134; B60R 19/48; B60R 21/34

(57) ABSTRACT

An apparatus for ascertaining the surroundings for a vehicle includes a housing configured to receive a device for ascertaining the surroundings of the vehicle and a movement device. The movement device is connected to the housing and is coupled to a structural element of the vehicle. The movement device is configured to move the housing relative to the structural element in response to a triggering signal in order to initiate a protective function in a case of an impact effect that is acting upon the vehicle.

This application claims priority under 35 U.S.C. § 119 to patent application no. DE 10 2018 211 917.1, filed on Jul. 18, 2018 in Germany, the disclosure of which is incorporated herein by reference in its entirety.

### BACKGROUND

The disclosure is based on an apparatus or a method according to the generic type of the independent claims.

Vehicles may comprise a device for ascertaining the surroundings having sensors that are integrated in the vehicle. These sensors may be arranged in a potential collision area.

### SUMMARY

Against this background, with the approach proposed here an apparatus for ascertaining the surroundings for a vehicle, a vehicle having an apparatus for ascertaining the surroundings for a vehicle and a method for initiating a protective function in the case of an impact effect that is acting upon a vehicle in accordance with the main claims are proposed. Advantageous further developments and improvements of the apparatus that is disclosed in the independent claim are possible by means of the measures that are stated in the dependent claims.

It is possible using the approach proposed here for a device for ascertaining the surroundings to move relative to a structural element of the vehicle in the case of an impact effect that is acting upon the vehicle. It is advantageously possible in this manner to prevent damage to the device for ascertaining the surroundings. As a consequence, costs and repair times may be avoided. Moreover, the safety of unprotected road users, for example pedestrians, a cyclist or a motorbike rider may be increased.

An apparatus for ascertaining the surroundings for a vehicle is proposed. The apparatus comprises a housing for receiving a device for ascertaining the surroundings of the vehicle and a movement device. The movement device is connected to the housing and may be coupled to a structural element of the vehicle. The movement device is embodied for the purpose of moving the housing relative to the structural element in response to a triggering signal in order to initiate a protective function in the case of an impact effect that is acting upon the vehicle.

The vehicle may be a motor vehicle, by way of example a car, a bus, a commercial vehicle or a transport vehicle for transporting goods or people. The vehicle may be embodied as a vehicle having an automated driving operation, in other words as a vehicle that drives without a driver, by way of example in the form of a self-driving motor vehicle. The apparatus for ascertaining the surroundings may be embodied in order to ascertain the surroundings of the vehicle, by way of example using a suitable sensor. In addition or alternatively, the apparatus may be embodied in order to make it easier to ascertain the surroundings by way of example by means of a sensor or a driver of the vehicle. For this purpose, the apparatus may be embodied by way of example in order to ascertain the surroundings using a cone of light. The term “apparatus” may be understood consequently by way of example both as a sensor system as well as a headlight. The device for ascertaining the surroundings may accordingly be a sensor device, by way of example in the form of a LiDAR sensor or radar sensor or a light source. The housing may entirely or in part encompass the device for ascertaining the surroundings. The device for ascertaining the surroundings may be connected to the housing in a detachable or non-detachable manner. The housing may consequently also represent an outer shell of the device for ascertaining the surroundings. The term “structural element of the vehicle” may be understood by way of example as a bumper, a side member or cross member or another body component. The movement device may be coupled to the structural element in a mechanical or magnetic manner. The movement device may be embodied in order to initiate the relative movement between the housing and the structural element by means of deforming at least one element of the movement device. In addition or alternatively, the movement device may be embodied in order to initiate the relative movement utilizing energy that is stored in the movement device. The movement device may be arranged by way of example between the housing and the structural element. The triggering signal may be by way of example an electrical signal or a radio signal. The triggering signal may represent a signal that is provided by an external device such as a sensor device or a control device of the vehicle or a signal that is provided by another vehicle. The triggering signal may be used by the movement device in order to trigger the movement of the housing relative to the structural element. Consequently, the triggering signal may be referred to as a control signal for actuating the movement device. Alternatively, the triggering signal may be a force that may act upon the housing. The term “initiate the protective function in the case of an impact effect that is acting upon the vehicle” may be understood as initiating the movement of the housing in order to prevent possible damage and in addition or alternatively to protect road users that may be injured. For this purpose, the housing may be moved by way of example in the direction of the vehicle interior and in addition or alternatively may be retracted into the vehicle body.

In accordance with one embodiment, the apparatus may comprise the device for ascertaining the surroundings. The device for ascertaining the surroundings may be received in the housing. Advantageously, the device for ascertaining the surroundings may be moved in this manner together with the housing relative to the structural element. In particular, the device for ascertaining the surroundings may comprise a light source or a sensor device for ascertaining the surroundings. The light source may be by way of example a part of the vehicle lighting such as a front headlight. The sensor device may comprise by way of example an optical sensor such as a monocamera and a stereo camera or a LiDAR sensor or the sensor device may comprise another sensor such as a radar sensor or ultrasonic sensor or a combination of the mentioned embodiments of the device for ascertaining the surroundings. Advantageously, the housing of the apparatus may be shaped corresponding to the device for ascertaining the surroundings that is to be received.

In accordance with one embodiment, the movement device may comprise at least one holding element that may be arranged between the housing and the structural element. The holding element may be embodied for the purpose of fixing the housing to the structural element and releasing said housing in response to the triggering signal. The holding element may be shaped by way of example as a mounting bracket of the housing and may be rod-shaped around which an impact effect that occurs in normal driving behavior is stable and in response to the triggering signal said holding element may break off or bend to the side, for this purpose the holding element may comprise by way of example at least one predetermined breaking point. In accordance with this embodiment, the housing may move relative to the structural element by means of releasing the housing by means of the holding element. In addition or alternatively, the holding element may be embodied in order to retract by means of springing back in response to the triggering signal and subsequently to return into the starting position similar to a movement damping procedure by means of an air cushion. The holding element may also be flexibly shaped as a yielding holding arrangement in order, after the housing is released, to fix the housing back on the structural element. Advantageously, in this manner it is possible to fix and release the housing to the structural element and it is possible in a cost-effective manner to realize a relative movement between the housing and the structural element.

Moreover, in accordance with one embodiment the movement device may comprise at least one housing-side pushing element and one structure-side pushing element. The pushing elements may be embodied so as to be displaced against one another in response to the triggering signal in order to move the housing relative to the structural element. The housing-side pushing element may be connected to the housing and the structure-side pushing element may be connected to the structural element. The housing-side pushing element may be by way of example an element that may be inserted into a rail and the structure-side pushing element may be the corresponding rail. The rail may be by way of example a saw tooth-shaped rail and the insertable element may be shaped as a holder having a spherical end. In addition or alternatively, the pushing elements may be embodied as a tube-in-tube construction. For this purpose, the housing-side pushing element may be shaped by way of example as a tapering tube and the structure-side pushing element may be shaped as a matrix for the tube or as a further tube having a greater inner diameter than the outer diameter of the tube. The tube may taper in response to the triggering signal and may be pushed into the matrix or the further tube. Advantageously, in accordance with this embodiment the housing may move in a controlled manner, as a result of which damage to the apparatus and to the device for ascertaining the surroundings that is received in accordance with one exemplary embodiment in the housing may be prevented.

The movement device in accordance with one embodiment may also comprise a resilient device. The resilient device may comprise a resilient actuator and at least one resilient element for storing potential energy, said resilient element being arranged between the housing and the structural element. The resilient actuator may be embodied so as to render possible a conversion of the potential energy into kinetic energy in response to the triggering signal in order to move the housing relative to the structural element. The resilient element may be by way of example a pre-stressed mechanical spring that is pre-stressed to a minimum of its length in order to store potential energy and is held together by means of the resilient actuator. The resilient actuator may be actuated by way of example electrically and may be embodied in order to release the resilient element in response to the triggering signal with the result that the potential energy of the resilient element may be converted into kinetic energy in order to move the housing. Advantageously, the housing may be moved in this manner relative to the structural element in a spring-driven manner, which in the case of an impact effect may prevent or reduce damage to the apparatus.

In accordance with one embodiment, the movement device may moreover comprise at least one housing-side magnet, a structure-side magnet and a fixing actuator. The fixing actuator may be embodied in order to interrupt a fixing arrangement between the magnetic elements in response to the triggering signal in order to render it possible to move the housing relative to the structural element using a magnetic force that acts between the magnets. The housing-side magnet and the structure-side magnet may be by way of example opposing or identically poled solenoid magnets that are held together by means of the magnetic fixing actuator. The magnets may be arranged in such a manner that they repel one another owing to their magnetic fields. The fixing actuator may be actuated by way of example electrically and may be embodied so as to fix the magnets to one another. The fixing actuator may be embodied in order to release a fixing arrangement of the magnets in response to the triggering signal with the result that the movement of the housing relative to the structural element is initiated using the magnetic force that acts between the magnets. Advantageously, the movement device may be realized in this manner in a cost-effective and space-saving manner.

Moreover, the movement device in accordance with one embodiment may comprise at least one housing-side magnetic element, a structure-side magnetic element and an electromagnet for providing a magnetic field. The electromagnet may be embodied in order to initiate a change of the magnetic field that is provided by the electromagnet in response to the triggering signal in order to render it possible to move the housing relative to the structural element using a magnetic force that acts between the magnetic elements. In this case, the housing-side magnetic element may be magnetic, and the structure-side magnetic element may be ferromagnetic, by way of example the housing-side magnetic element may be a permanent magnet and the structure-side magnetic element may be realized as a ferromagnetic plate. The electromagnet may be shaped as a magnetic coil. The electromagnet may be embodied so as to produce a magnetic field that opposes the permanent magnet in order to weaken the magnetic force of the permanent magnet. The electromagnet may be deactivated or weakened in response to the triggering signal with the result that the magnetic force of the permanent magnet is available in order to initiate the relative movement. The housing may then be moved relative to the structural element using the magnetic force that acts between the housing-side permanent magnet and the structure-side ferromagnetic magnetic element. Advantageously, this embodiment renders possible a reversible and therefore cost-effective and maintenance-free movement of the housing relative to the structural element.

In accordance with one embodiment, the triggering signal may be a force that is acting upon the housing in the case of an impact effect that is acting upon the vehicle. By way of example, the triggering signal may represent a force that is coupled into the housing as a result of a collision with another vehicle, road user or object. The term “triggering signal” may consequently be understood as the force that is acting upon the housing as a mechanical momentum. This renders it possible to realize a particularly rapid and cost-effective reaction chain.

In accordance with one embodiment, the triggering signal may represent a control signal that is received via an interface to a further sensor device or the device for ascertaining the surroundings. The control signal may represent a signal that is provided in response to ascertaining an impact effect that has acted or will act upon the vehicle. The interface may be by way of example a radio interface for receiving the control signal as an external signal or a wire-connected interface to the sensor device or device for ascertaining the surroundings of the vehicle. The sensor device and in addition or alternatively the device for ascertaining the surroundings may also be received in the housing of the apparatus. The triggering signal may be used in this case in order to actuate the movement device or a component of the movement device such as the electrically controllable resilient actuator or electromagnet in response to identifying the impact effect that is acting upon the vehicle.

Moreover, the apparatus in accordance with one embodiment may comprise the further sensor device. The further sensor device may be embodied so as to identify an impact effect that will act upon the vehicle in the future. The further sensor device may also be the device for ascertaining the surroundings that is received in the housing. The further sensor device may be embodied so as to identify the impact effect that will act upon the vehicle in the future in the case of a rapidly approaching object or alternatively or optionally in the case of a high Ego speed. The triggering signal in this case may be provided owing to an event that is expected to occur in the future. Advantageously, the movement of the housing relative to the structural element consequently may already have occurred prior to the effect of the impact effect on the vehicle, as a result of which the apparatus and in accordance with one embodiment the device for ascertaining the surroundings may be protected prior to being damaged as a result of the impact effect. It is consequently possible to obtain a time advantage that may be used to protect the device for ascertaining the surroundings.

A vehicle having the structural element and having an embodiment of the abovementioned apparatus is also proposed, wherein the movement device of the apparatus is coupled to the structural element.

Moreover, a method for initiating a protective function in the case of an impact effect that is acting upon a vehicle is proposed. In this case, the vehicle comprises an embodiment of the abovementioned apparatus. The method comprises a movement step. During the movement step, the housing is moved relative to the structural element in response to the triggering signal in order to initiate the protective function in the case of an impact effect that is acting upon the vehicle.

The method in accordance with one embodiment may moreover comprise an identifying step and a providing step. During the identifying step, it is possible to identify the impact effect that is acting upon the vehicle. During the providing step, it is possible to provide the triggering signal in response to identifying the impact effect that is acting upon the vehicle. The identifying and providing steps may optionally be performed prior to the movement step.

This method may be implemented by way of example in software or hardware or in a mixed form of software and hardware, by way of example in a control device.

### BRIEF DESCRIPTION OF THE DRAWINGS

Exemplary embodiments of the approach that is proposed here are illustrated in the drawings and are further explained in the following description. In the drawings:

FIG. 1 illustrates schematically a vehicle having an apparatus for ascertaining the surroundings in accordance with one exemplary embodiment;

FIG. 2 illustrates an arrangement of a device for ascertaining the surroundings on a vehicle in accordance with one exemplary embodiment;

FIG. 3 illustrates schematically an apparatus for ascertaining the surroundings of a vehicle in accordance with one exemplary embodiment;

FIG. 4 illustrates schematically an apparatus for ascertaining the surroundings of a vehicle in accordance with one exemplary embodiment;

FIG. 5 illustrates schematically an apparatus for ascertaining the surroundings of a vehicle in accordance with one exemplary embodiment;

FIG. 6 illustrates schematically an apparatus for ascertaining the surroundings of a vehicle in accordance with one exemplary embodiment;

FIG. 7 illustrates schematically an apparatus for ascertaining the surroundings of a vehicle in accordance with one exemplary embodiment;

FIG. 8 illustrates schematically an apparatus for ascertaining the surroundings of a vehicle in accordance with one exemplary embodiment; and

FIG. 9 illustrates a flow diagram of a method for initiating a protective function in the case of an impact effect that is acting upon a vehicle in accordance with one exemplary embodiment.

### DETAILED DESCRIPTION

In the following description of advantageous exemplary embodiments of the present disclosure, identical or similar reference numerals are used for the elements that are illustrated in the various figures and act in a similar manner, wherein a repeated description of these elements is omitted.

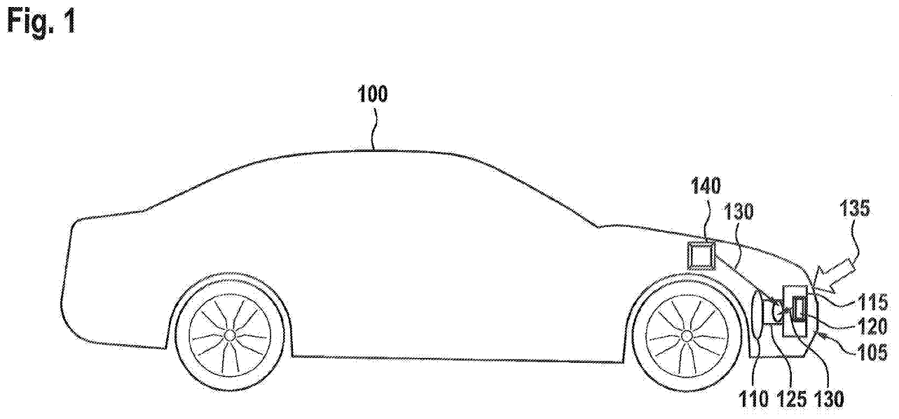

FIG. 1 illustrates schematically a vehicle 100 having an apparatus 105 for ascertaining the surroundings in accordance with one exemplary embodiment. The vehicle 100 comprises a structural element 110 and the apparatus 105. The apparatus comprises a housing 115 for receiving a device 120 for ascertaining the surroundings of the vehicle 100 and a movement device 125. The movement device 125 is connected to the housing 115 and to the structural element 110. The movement device 125 is embodied for the purpose of moving the housing 115 relative to the structural element 110 in response to a triggering signal 130 in order to initiate a protective function in the case of an impact effect 135 that is acting upon the vehicle 100.

In accordance with the exemplary embodiment illustrated here, the device 120 for ascertaining the surroundings is received in the housing. The device 120 for ascertaining the surroundings comprises in particular a light source such as a headlight or a sensor device having by way of example a LiDAR sensor for ascertaining the surroundings.

The triggering signal 130 in accordance with one exemplary embodiment represents a force that is acting upon the housing 115 in the case of an impact effect 135 that is acting upon the vehicle 100. Alternatively, the triggering signal 130 represents a control signal that is received via an interface to a sensor device 140 or the device 120 for ascertaining the surroundings. The sensor device 140 is embodied as a component of the vehicle 100 and in addition or alternatively as a part of the apparatus 105. In accordance with different exemplary embodiments, the sensor device 140 is embodied so as to identify an impact effect 135 that has already occurred or that will act upon the vehicle 100 in the future.

It is possible using one exemplary embodiment of the apparatus 105 that is illustrated here with the aid of automated reaction chains to protect unprotected road users that collide with the vehicle 100 and also to minimize damage to the Ego vehicle or to the other vehicle involved in the accident. It is possible by means of the apparatus 105 in the event of a collision to initiate one or multiple reaction chains in an automated manner in order to suitably bring the housing 115 into movement. It is possible by means of the movement to initiate a protection against injuries by means of the housing 115 or to minimize damage to the housing 115 or the device 120 for ascertaining the surroundings that is received in the housing 115. The step of triggering the reaction chain is performed in accordance with one exemplary embodiment by means of the triggering signal 130, optionally based on an external signal, which is provided by an external sensor device or the sensor device 140 by way of example in the form of standard acceleration sensors in order to trigger an airbag. In addition or alternatively, the triggering signal 130 is also provided with the aid of an inertia sensor system that is installed internally in the housing 115 in the form of the received device 120 for ascertaining the surroundings in order to minimize the triggering latency.

Moreover, the triggering procedure of the reaction chain that is initiated by means of the triggering signal 130 is performed optionally or alternatively based upon ascertaining the future impact effect. In this case, the ascertaining step is performed in accordance with one exemplary embodiment using the device 120 for ascertaining the surroundings that is received in the housing 115 in order to be protected. This is expedient by way of example in the case of an object that is rapidly approaching the vehicle 100 or alternatively or optionally at a high Ego speed of the vehicle 100. In this manner, a future impact effect 135 is optionally identified, which represents a time advantage since the movement of the housing 115 relative to the structural element 110 is already possible prior to a collision of the vehicle.

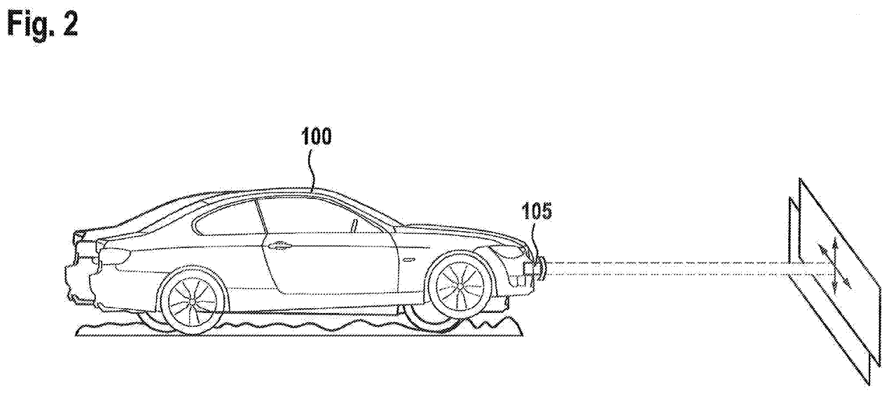

FIG. 2 illustrates an arrangement of an apparatus 105 for ascertaining the surroundings on a vehicle 100 in accordance with one exemplary embodiment. The apparatus 105 illustrated here corresponds to or resembles essentially the apparatus that is described with the aid of FIG. 1. In the illustration here, a typical installation site of the apparatus 105 is illustrated in an exemplary manner in the vehicle front end of the vehicle 100. In addition or alternatively, the apparatus 105 may also be arranged on the sides, in the rear, by way of example on the bumper, in the side mirrors, behind the windscreen or on the roof of the vehicle 100.

It is possible with the increasing automation of current and future generations of motor vehicles to achieve a direct dependency of sensors for ascertaining the surroundings such as camera systems, radars, LiDAR, ultrasonic sensor systems or similar. These sensors for ascertaining the surroundings are integrated by way of example into the apparatus 105 illustrated here, by way of example by means of an inside-out configuration. In this case, owing to an improved ascertaining situation the sensors may be integrated into the vehicle 100 into the outer edges of the vehicle 100 so that said sensors protrude from said outer edges, as is illustrated in FIG. 2. In accordance with this exemplary embodiment, a device for ascertaining the surroundings of the apparatus 105, which is integrated by way of example in the vehicle front end in a bumper, in part protrudes out of the vehicle body.

In order to avoid repair costs in the event of damage as a result of an impact effect that is acting upon the vehicle 100, the device for ascertaining the surroundings illustrated here is arranged in the housing of one exemplary embodiment that is described of the apparatus 105 for ascertaining the surroundings. If a collision with an unprotected road user such as a pedestrian or a two-wheeled means of transportation such as a bicycle occurs, the sensors of the device for ascertaining the surroundings of the apparatus 105 on the vehicle outer edges advantageously do not represent an increased risk by means of the movement of the device for ascertaining the surroundings relative to the structural element.

A use of the apparatus 105 for ascertaining the surroundings so as to initiate a protective function in relation to reducing resulting damage to the vehicle 100 and in relation to pedestrian protective measures is also advantageous in relation to development in the field of mobility solutions such as shuttles or robotic taxis and integration of optional multiple sensors for ascertaining the surroundings per vehicle 100.

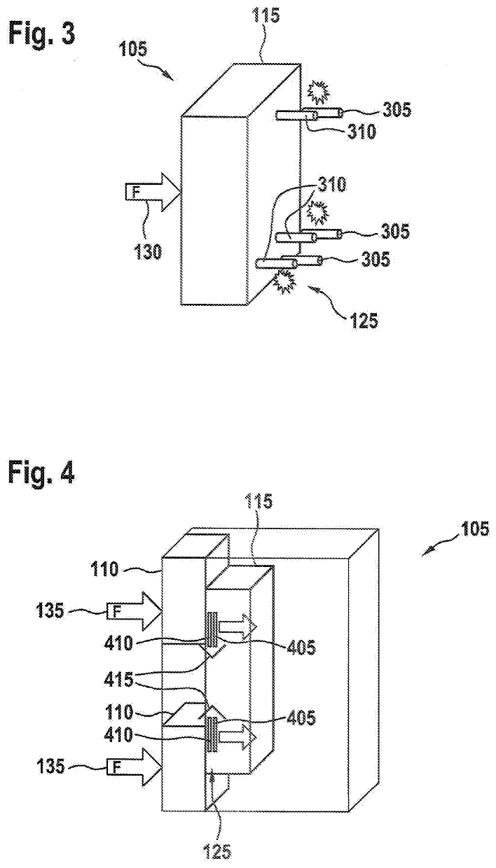

FIG. 3 illustrates schematically an apparatus 105 for ascertaining the surroundings of a vehicle in accordance with one exemplary embodiment. The apparatus 105 is by way of example one exemplary embodiment of the apparatus that is described with the aid of FIG. 1.

The movement device 125 of the apparatus 105 that is illustrated here comprises, in accordance with one exemplary embodiment, at least one holding element 305 that may be arranged between the housing and the structural element. In accordance with various exemplary embodiments, the movement device 125 in this case may comprise a single holding element 305 or a plurality of holding elements 305. The at least one holding element 305 is embodied for the purpose of fixing the housing 115 to the structural element and to release said housing in response to the triggering signal 130.

The movement device 125 is embodied in order to hold the housing 115 in a normal operation of the vehicle via the holding elements 305 in an operating position that is suitable for the operation of the device for ascertaining the surroundings that is encompassed by the housing 115. Moreover, the movement device 125 is embodied in order to render it possible to move the housing 115 from the operating position into a protective position if such a position displacement is perceived as expedient owing to an impact effect that is acting upon the vehicle in order to protect the device for ascertaining the surroundings or in order to protect people. In accordance with this exemplary embodiment, at least one part of the force F in the case of such an impact effect that is acting upon the vehicle is guided as the triggering signal 130 to the housing 115. The triggering signal 130 in this case acts in an exemplary manner on one side of the housing 115 that is arranged opposite the movement device 125.

The movement device 125 comprises here in an exemplary manner three rod-shaped holding elements 305. In the assembled state, the free ends of the holding elements 305 that are illustrated in FIG. 3 are fastened on the structural element of the vehicle. Each holding element 305 comprises here a predetermined breaking point 310. The movement device 125 having the holding element 305 may also be referred to as a yielding holding arrangement by means of the predetermined breaking point 310 of each holding element 305. As an alternative to the predetermined breaking point 310, another realization of the procedure for releasing the fixed housing 115 is also possible, wherein the holding element 305 may be shaped in a flexible manner or may bend to the side.

In accordance with this exemplary embodiment, the force F that acts by means of the triggering signal 130 upon the housing 115 and via the housing 115 upon the holding elements 305 initiates the procedure for deforming, here by way of example breaking, the holding element 305. Moreover, the force F that acts by means of the triggering signal 130 upon the housing 115 initiates the movement of the housing 115 into the protective position. In this case, the housing 115 moves in the direction of the structural element.

A passive and non-destructive and therefore also reversible reaction chain of the apparatus 105 in response to the triggering signal 130 in the case of a collision or a force that is acting upon the vehicle occurs by means of a yielding holding arrangement of the housing 115 using the holding elements 305 that are illustrated here. The embodiment of the fixing arrangement of the housing 115, which is illustrated here, and therefore the holding arrangement by way of example of a sensor of the device for ascertaining the surroundings, said sensor being received in the housing 115, is stable in the case of mechanical couplings, the frequencies and amplitudes of which fall under normal conditions such as normal driving behavior, airstream or off-road scenarios. The holding arrangement in the form of the holding elements 305 is flexible or breaks or bends to the side in the case of mechanical couplings, the frequencies and amplitudes of which occur typically in the case of the impact effect of a collision with another vehicle, an obstacle or another road user.

FIG. 4 illustrates schematically an apparatus 105 for ascertaining the surroundings of a vehicle in accordance with one exemplary embodiment. The apparatus 105 is by way of example an exemplary embodiment of the apparatus that is described with the aid of FIG. 1. In accordance with the exemplary embodiment that is illustrated here, the apparatus 105 comprises at least one housing-side magnet 405 and one structure-side magnet 410, and also a fixing actuator 415. The housing-side magnet 405 is fixedly connected to the housing 115 and the structure-side magnet 410 is fixedly connected to the structural element 110. In this case, the magnets 405, 410 are arranged between the structural element 110 and the housing 115.

In the normal operating state of the vehicle, the fixing actuator 415 is embodied in order to fix the housing-side magnet 405 on the structure-side magnet 410. In this case, the magnets 405, 410 may be held pressed directly onto one another. The fixing actuator 415 is embodied in order to interrupt a fixing arrangement between the magnets 405, 410 in response to the triggering signal. In accordance with this exemplary embodiment, the magnets 405, 410 are poled in such a manner that they repel one another. After the fixing arrangement is interrupted by means of the fixing actuator, the magnets 405, 410 move away from one another. As a consequence, the housing 115 is moved out of the operating position into the protective position. The movement of the housing 115 relative to the structural element 110 is consequently rendered possible using the magnetic force that acts between the magnets 405, 410.

The structural element 110 in accordance with this exemplary embodiment comprises a through-going opening. The housing 115 here comprises in an exemplary manner two housing-side magnets 405 that respectively by means of a fixing actuator 415 and a structure-side magnet 410 each connect the housing 115 to a structural element 110. The two pairs of magnets 405, 410 are arranged on sides of the through-going opening that lie opposite one another.

As an alternative to a plurality of pairs of magnets 405, 410, a pair of annular magnets 405, 410 may also be used. In this case, a by way of example likewise annular fixing actuator 415 is sufficient.

The illustrated structural element 110 is embodied in an exemplary manner as a part of the front body, which optionally comprises foam material in order to protect pedestrians. The two magnets 405, 410 may be embodied as solenoid magnets or as permanent magnets. The magnets 405, 410 are fixed by means of the fixing actuator 415 and are held together by means of the fixing actuator 415. The fixing actuator 415 may be optionally controlled electrically. In this case, the fixing actuator 415 may be actuated using the triggering signal in the form of an electrical control signal in such a manner that the fixing actuator 415 interrupts the fixing arrangement between the magnets 405, 410. As a consequence, the housing 115 is moved relative to the structural element 110 using the magnetic force that acts between the magnets 405, 410, here said housing is moved away from the structural element 110. This is initiated by means of the magnets 405, 410 repelling one another.

FIG. 4 illustrates schematically the impact effect 135 that acts in accordance with this exemplary embodiment directly upon an outer wall of the structural element 110. The force F that acts via the impact effect 135 upon the structural element 110 is ascertained by a device for ascertaining the surroundings that is arranged in the housing 115 or another sensor system that is arranged in the vehicle and in response to ascertaining the impact effect 135 the triggering signal is provided to the fixing actuator 415 or fixing actuators 415 in order to move the housing 115 away from the structural element 110.

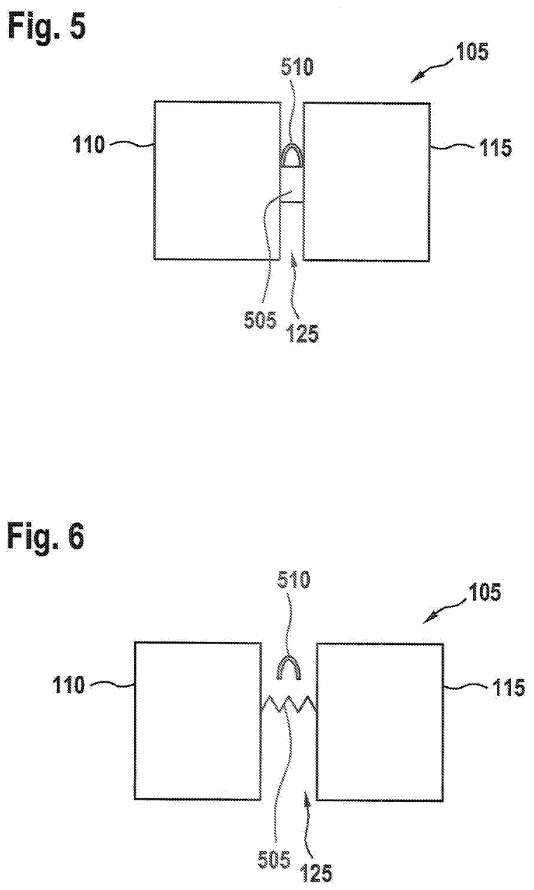

FIG. 5 illustrates schematically an apparatus 105 for ascertaining the surroundings of a vehicle in accordance with one exemplary embodiment. The apparatus 105 is by way of example an exemplary embodiment of the apparatus that is described with the aid of FIG. 1. The movement device 125 comprises in accordance with the exemplary embodiment illustrated here a resilient device having at least one resilient element 505 that is arranged between the housing 115 and the structural element 110 in order to store potential energy. Moreover, the movement device 125 comprises a resilient actuator 510. The resilient actuator 510 is embodied so as to render possible a conversion of the potential energy into kinetic energy in response to the triggering signal in order to move the housing 115 relative to the structural element 110. In the exemplary embodiment illustrated here, the resilient element 505 is illustrated as a pre-stressed spring having a high energy storage effect, which is pre-stressed to a minimum of its length. The resilient element 505 is held together in the pre-stressed state by means of the resilient actuator 510 in the form of an electrically controllable actuator. A conversion of the potential energy into kinetic energy in response to the triggering signal in the form of an electrical signal, by way of example by means of an impact effect of a collision of the vehicle, is rendered possible as a reaction chain in order to render it possible to move the housing 115 relative to the structural element 110. The housing 115 is moved by means of the kinetic energy by means of releasing the resilient element 505 that is connected to the structural element 110 in order for the housing to be pushed by way of example away from the structural element 110 into the vehicle body. In this case, the housing 115 is retracted into the vehicle body in a slightly resilient manner.

FIG. 6 illustrates schematically an apparatus 105 for ascertaining the surroundings of a vehicle in accordance with one exemplary embodiment. It is a further situation of the apparatus illustrated in FIG. 5. In the situation illustrated here, the resilient element 505 is not held together by means of the resilient actuator 510 in the pre-stressed state but rather in the released state. The housing 115 and the structural element 110 comprise a distance with respect to one another, which corresponds to the resilient length of the resilient element 505. The situation illustrated here illustrates in an exemplary manner the apparatus 105 and the structural element 110 after a movement of the housing 115 relative to the structural element 110, said movement being performed in response to the triggering signal, in order to initiate the protective function in the case of an impact effect that is acting upon the vehicle. The housing 115 has been moved for this purpose away from the structural element 110 in the direction of the vehicle interior, wherein the housing 115 has been moved by means of the resilient element 505.

In an alternative to the exemplary embodiment described with the aid of FIGS. 5 and 6, the resilient element 505 may also be held in a state in which they are pulled apart from one another using the resilient actuator 510. The resilient element 505 may be released in response to the triggering signal and then may initiate a movement of the housing 115 in the direction of the structural element 110.

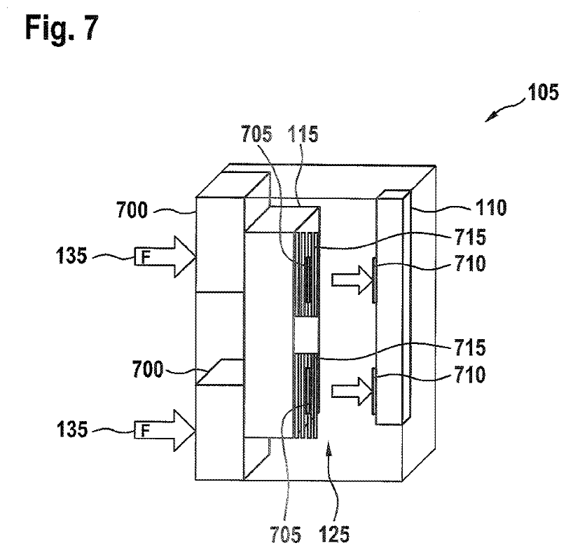

FIG. 7 illustrates schematically an apparatus 105 for ascertaining the surroundings of a vehicle in accordance with one exemplary embodiment. The apparatus 105 is by way of example an exemplary embodiment of the apparatus that is described with the aid of FIG. 1. The housing is arranged in an exemplary manner on the inner side of a part of the front body 700 of the vehicle. In this case, the front body 700 corresponds to the structural element that is described with the aid of FIG. 4 and the housing 115 is accordingly arranged at the height of the through-going opening of the front body 700. The housing 115 is arranged between the front body 700 and a structural element 110 of the vehicle. In the operating state of a device for ascertaining the surroundings that is encompassed by the housing 115 there is a gap between the housing 115 and the structural element 110. If the housing 115 is moved into a protective position using the movement device 105, the housing 115 is moved away from the front body 700 and toward the structural element 110.

For this purpose, the movement device 125 in accordance with this exemplary embodiment comprises at least one housing-side magnetic element 705, a structure-side magnetic element 710 and an electromagnet 715 for providing a magnetic field. The electromagnet 715 is embodied in order to initiate a change of the magnetic field in response to the triggering signal in order to render it possible using a magnetic force that acts between the magnetic elements 705, 710 to move the housing 115 relative to the structural element 110. For this purpose, the magnetic elements 705, 710 are arranged opposite one another and are embodied in such a manner that the magnetic elements 705, 710 attract one another.

In accordance with the illustrated exemplary embodiment, the housing-side magnetic element 705 is embodied as a magnet and the structure-side magnetic element 710 is embodied as a ferromagnetic element. The electromagnet 715 is embodied in order to generate a magnetic field in the operating state of the device for ascertaining the surroundings that is encompassed by the housing 115 in such a manner that said magnetic field opposes the magnetic field of the housing-side magnetic element 705. As a consequence, the magnetic field of the housing-side magnetic element 705 is weakened at least to the extent that the magnetic force that acts between the magnetic elements 705, 710 does not lead to a movement of the housing 1115 in the direction of the structural element 110.

The housing comprises in accordance with the exemplary embodiment illustrated here two housing-side magnetic elements 705 that are embodied as permanent magnets. An electromagnet 715 is arranged in the region of each of the two housing-side magnetic elements 705, said electromagnet here being shaped as a magnetic coil that may be actuated electrically. The structure-side magnetic element 710 in the form of a ferromagnetic plate is arranged opposite each of the two housing-side magnetic elements 705 in the direction of the vehicle interior of the vehicle. In the exemplary embodiment illustrated here, the two permanent magnets of the housing-side magnetic elements 705 are weakened by means of the respective electromagnet 715. The electromagnet 715 is deactivated in response to the triggering signal and the two housing-side magnetic elements 705 that are illustrated in an exemplary manner attract the structure-side magnetic element 710 in the form of the ferromagnetic plates illustrated here in order to move the housing 115 relative to the structural element 110 in the direction of the structure-side magnetic elements 710 and therefore in the direction of the vehicle interior of the vehicle.

In accordance with a further exemplary embodiment, the housing-side magnetic element 705 is embodied as a magnet and the structure-side magnetic element 710 is embodied as a further magnet. In this case, the magnetic elements 705, 710 are poled in such a manner that the magnetic elements 705, 710 attract one another. In accordance with one exemplary embodiment, a magnetic field results from the superposition of the magnetic field of the housing-side magnetic element 705 and the magnetic field of the electromagnet 715 in such a manner that the structure-side magnetic element 710 is repelled. The change of the magnetic field of the electromagnet 715, which is initiated by means of the triggering signal, initiates at least one weakening procedure and in accordance with one exemplary embodiment a procedure for interrupting the magnetic field of the electromagnet 715.

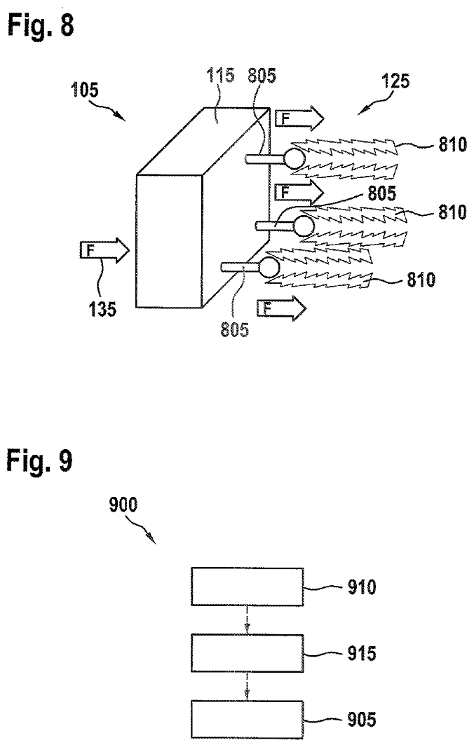

FIG. 8 illustrates schematically an apparatus 105 for ascertaining the surroundings of a vehicle in accordance with one exemplary embodiment. The apparatus 105 is by way of example an exemplary embodiment of the apparatus that is described with the aid of FIG. 1.

The movement device 125 in accordance with the exemplary embodiment illustrated here comprises at least one housing-side pushing element 805 and one structure-side pushing element 810. The pushing elements 805, 810 are embodied so as to be displaced against one another in response to the triggering signal in order to move the housing 115 relative to the structural element 110.

In the exemplary embodiment that is illustrated here, three housing-side pushing elements 805 and three corresponding structure-side pushing elements 810 are illustrated in an exemplary manner. In a ratchet manner similar to that of a cable tie function, in the case of a suitably large force effect in the form of the force F that is represented by means of the triggering signal 135, said force F acting upon the housing 115 in the case of an impact effect that is acting upon the vehicle, the housing-side pushing element 805 is displaced in the direction of the structure-side pushing element 810. In accordance with the exemplary embodiment that is illustrated here, the structure-side pushing element 810 in this case is shaped in the manner of a rail that is at least in part to receive the housing-side pushing element 805 in order to move the housing 115 relative to the structural element, and in this case to move the housing 115 in the direction of the structural element. The housing-side pushing element 805 is shaped in an exemplary manner as a rod-shaped holder having spherical ends that are arranged on a side that is remote from the housing 115. The structure-side pushing element 810 is shaped in an exemplary manner as a saw tooth-shaped rail into which the housing-side pushing element 805 is pushed in response to the triggering signal, as a result of which the housing 115 is displaced into the vehicle interior. The spherical end of the housing-side pushing element 805 in this case optionally remains outside of the rail of the structure-side pushing element 810 and is supported by said structure-side pushing element.

Alternatively, the housing-side pushing element 805 is shaped as a tube that is retracted in response to the triggering signal 135 into the structure-side pushing element 810 that is shaped as a further tube or matrix. If the tube of the housing-side pushing element 805 is loaded corresponding to an impact effect that does not correspond to the regular driving operation of the vehicle, the tube of the housing-side pushing element 805 thus yields with a defined force, tapers and is pushed into the matrix or the further tube of the structure-side pushing element 810.

In the case of the two described variants of the embodiment of the pushing elements 805, 810, the pushing elements are displaced against one another in order to move the housing 115 relative to the structural element in response to the triggering signal and therefore only after a sufficiently large force or characteristic frequency of a collision with the result that said displacement is not triggered erroneously during the regular driving operation. For this purpose, the free ends of the pushing elements 810 that are illustrated in FIG. 8 are connected to the structural element. The displacement of the pushing elements 805, 810 against one another fixes the housing 115 in accordance with one exemplary embodiment onto the structural element with the result that the connection may not detach and the housing 115 does not fall out of the vehicle and is not damaged after the movement of the housing 115 in response to the triggering signal 135.

The pushing elements 805, 810 may be used in addition or as an alternative to the holding elements that are described with the aid of FIG. 3. The mounting arrangement of the housing 115 by way of example by means of the pushing elements 805, 810 that are illustrated here or the holding elements that are described with the aid of FIG. 3 is embodied optionally in order to be able to retract under load and to return after the load into the position of the starting position prior to the impact effect or prior to the response to the triggering signal as a result of which the movement of the housing 115 relative to the structural element is reversible and therefore maintenance free.

FIG. 9 illustrates a flow diagram of a method 900 for initiating a protective function in the case of an impact effect that is acting upon a vehicle in accordance with one exemplary embodiment. In this case, the vehicle comprises an exemplary embodiment of the abovementioned apparatus. The method 900 comprises a movement step 905. In the movement step 905, the housing is moved relative to the structural element in response to the triggering signal in order to initiate the protective function in the case of the impact effect that is acting upon the vehicle.

The method 900 optionally moreover comprises an identifying step 910 and a providing step 915. In the identifying step 910, the impact effect that is acting upon the vehicle is identified. In the providing step 915, the triggering signal is provided in response to identifying the impact effect that is acting upon the vehicle. The steps 905 and 910 are performed in accordance with one exemplary embodiment prior to the step 905.

If an exemplary embodiment comprises an “and/or” link between a first feature and a second feature, this is thus to be read in such a manner that the exemplary embodiment in accordance with one embodiment comprises both the first feature as well as the second feature and in accordance with a further embodiment comprises either only the first feature or only the second feature.

What is claimed is:

1. An apparatus for ascertaining surroundings for a vehicle, comprising:
a housing; and
a movement device connected to the housing and coupled to a structural element of the vehicle, the movement device configured to move the housing relative to the structural element in response to a triggering signal in order to initiate a protective function in a case of an impact effect that is acting upon the vehicle.

2. The apparatus according to claim 1, further comprising:
a device configured to ascertain the surroundings, the device including a light source or a sensor device configured to ascertain the surroundings,
wherein the housing is configured to receive the device.

3. The apparatus according to claim 1, wherein the movement device includes at least one holding element arranged between the housing and the structural element, the at least one holding element configured fix the housing to the structural element and to release the housing in response to the triggering signal.

4. The apparatus according to claim 1, wherein:
the movement device includes at least one housing-side pushing element and at least one structure-side pushing element, and
the pushing elements are displaced against one another in response to the triggering signal in order to move the housing relative to the structural element.

5. The apparatus according to claim 1, wherein:
the movement device includes a resilient device having resilient actuator and at least one resilient element configured to store potential energy,
the at least one resilient element is arranged between the housing and the structural element, and
the resilient actuator is configured to convert potential energy of the at least one resilient element into kinetic energy in response to the triggering signal in order to move the housing relative to the structural element.

6. The apparatus according to claim 1, wherein:
the movement device includes at least one housing-side magnet, a structure-side magnet, and a fixing actuator,
the fixing actuator is configured to interrupt a fixing arrangement between the at least one housing-side magnet and the structure-side magnet in response to the triggering signal in order to move the housing relative to the structural element using a magnetic force acting between the at least one housing-side magnet and the structure-side magnet.

7. The apparatus according to claim 1, wherein:
the movement device includes at least one housing-side magnetic element, a structure-side magnetic element, and an electromagnet configured to output a magnetic field,
the electromagnet is configured to initiate a change of the magnetic field in response to the triggering signal in order to move the housing relative to the structural element using a magnetic force acting between the at least one housing-side magnetic element and the structure-side magnetic element.

8. The apparatus according to claim 1, wherein the triggering signal includes a force acting upon the housing in the case of the impact effect that is acting upon the vehicle.

9. The apparatus according to claim 2, wherein the triggering signal includes a control signal received via an interface to a further sensor device or the device configured to ascertain the surroundings.

10. The apparatus according to claim 2, further comprising:
a further sensor device configured to identify an impact effect that will act upon the vehicle at a future time.

11. A vehicle comprising:
a structural element; and
an apparatus configured to ascertain surroundings of the vehicle, the apparatus including a housing and a movement device connected to the housing and coupled to the structural element of the vehicle,
wherein the movement device is configured to move the housing relative to the structural element in response to a triggering signal in order to initiate a protective function in a case of an impact effect that is acting upon the vehicle.

12. A method for initiating a protective function in a case of an impact effect that is acting upon a vehicle, the vehicle including a structural element, the method comprising:
moving a housing of an apparatus relative to the structural element with a movement device of the apparatus in response to a triggering signal in order to initiate a protective function in the case of the impact effect that is acting upon the vehicle,
wherein the housing is configured to receive a device configured to ascertain the surroundings of the vehicle.

13. The method according to claim 12, further comprising:
identifying the impact effect that is acting upon the vehicle; and
generating the triggering signal in response to identifying the impact effect.
